(19) United States
(12) Patent Application Publication
(10) Pub. No.: US 2022/0145046 A1
(43) Pub. Date: May 12, 2022

(54) THERMOPLASTIC MOLDING COMPOSITION

(71) Applicant: BASF SE, Ludwigshafen am Rhein (DE)

(72) Inventors: Jens Cremer, Ludwigshafen (DE); Sebastian Wagner, Ludwigshafen (DE)

(21) Appl. No.: 17/433,277

(22) PCT Filed: Feb. 19, 2020
(86) PCT No.: PCT/EP2020/054295

§ 371 Date: Aug. 24, 2021

(30) Foreign Application Priority Data
Feb. 25, 2019 (EP) 19159209.6

(51) Int. Cl. C08K 7/14; C08K 3/04; C08L 77/02; C08K 5/20; C03C 3/087

(52) U.S. Cl. CPC C08K 7/14; C08K 3/04; C08L 77/02; C08L 2203/30; C03C 3/087; C08L 2203/12; C08L 2203/16; C08K 5/20

(57) ABSTRACT

Described herein is a method of using glass fibers having a tensile strength according to DIN ISO 527-5 of 86.0 to 92.0 GPa, a tensile elastic modulus according to DIN ISO 527-5 of 2600 to 3200 MPa and a softening point according to DIN ISO 7884-1 of 900° C. to 950° C. the method including using the glass fibers to increase the weld seam strength of shaped articles made of molding materials including thermoplastic polyamides.

The invention relates to the use of special glass fibers to increase the weld seam strength of injection molded shaped articles made of thermoplastic molding materials comprising thermoplastic polyamides and to corresponding thermoplastic molding materials, to processes for the production thereof, to the use thereof and to fibers, films or shaped articles made of the thermoplastic molding material.

Polyamides are among the polymers produced on a large scale globally and, in addition to their main fields of use in films, fibers and shaped articles (materials), serve a multitude of other end uses. Among the polyamides, polyamide-6 (polycaprolactam PA 6) and polyamide-6,6 (Nylon, polyhexamethyleneadipamide) are the polymers produced in the largest volumes. Most polyamides of industrial significance are semicrystalline thermoplastic polymers featuring a high thermal stability.

Shaped articles composed of polyamides may be produced by injection molding for example. This generally forms (dynamic) weld seams. A distinction is generally made between static and dynamic weld seams. Static weld seams are formed for example during the welding process when joining thermoplastic moldings. A dynamic weld seam is formed in a plastic component in the injection molding process due to confluence of at least two mass flows, for example downstream of cavities, due to wall thickness differences or due to a plurality of gates or injection sites in the mold. When two flow fronts collide, a weld seam, also known as a weld line or flow line, is formed at the point of confluence. These seams are apparent as visible lines. A weld seam is thus an often visible surface effect on injection molded parts.

A weld seam is a potential weak point in the component. On account of a volume expansion the flow fronts collide vertically and weld together. The lower the pressure and the temperature the lower the strength of the weld seam. Due to the shear acting during the injection molding process and the flow conditions reinforcing fibers often orient parallel to the weld seam. If the melt has already cooled to such an extent that a welding of the colliding melt fronts can no longer occur completely the weld seam is often apparent as a V-shaped notch at the surface. If tensile stresses were to occur in this region the notch effect brings about a stress superelevation at the weld seam which then acts as a pre-weakened breakage point.

The use of special glass fibers in polyamides is advantageous to achieve a high stiffness, tear strength and impact strength in addition to further desired properties:

When reinforcing polyamide molding compounds with glass fibers it is practically exclusively so-called E glass fibers (E=Electric) having a round cross section that are used. According to ASTM D578-00 E glass fibers consist of 52% to 62% of silicon dioxide, 12% to 16% of aluminum oxide, 16% to 25% of calcium oxide, 0% to 10% of borax, 0% to 5% of magnesium oxide, 0% to 2% of alkali metal oxides, 0% to 1.5% of titanium dioxide and 0% to 0.3% of iron oxide. E glass fibers have a density of 2.54 to 2.62 g/cm³, a tensile modulus of elasticity of 70 to 75 GPa, a tensile strength of 3000 to 3500 MPa and a breaking elongation of 4.5% to 4.8%, wherein the mechanical properties were determined on individual fibers having a diameter of 10 mm and a length of 12.7 mm at 23° C. and a relative humidity of 50%.

E glass is an aluminum borosilicate glass having a low proportion of alkali metal oxides (<2% by weight) and good electrical insulation properties. E glass fibers are particularly well suited for producing printed circuits and for plastics reinforcement. A major disadvantage of E glasses is their low acid resistance. E glasses are described inter alia in patent specification U.S. Pat. No. 3,876,481.

R glass (R=Resistance) is an alkaline earth metal-aluminum silicate glass. R glass fibers are employed in fields of application having high mechanical and thermal demands and have a fairly high tensile strength even at elevated temperature.

ECR glass (ECR=E glass Corrosion Resistance), described for example in U.S. Pat. No. 5,789,329, is a boron-free aluminum-lime-silicate glass having a low proportion of alkali metal oxides. ECR glass fibers have high acid resistance and good mechanical and electrical properties.

S glass (S=Strength) is a magnesium-aluminum-silicate glass. It was developed as a special glass for high mechanical demands, especially at elevated temperatures, and comprises more than 10 mol % of Al₂O₃.

EP 2 703 436 A1 describes polyamide molding materials which comprise not only particulate fillers but also high-strength glass fibers substantially composed of silicon dioxide, aluminum oxide and magnesium oxide. Preferred glass fibers comprise at least 5% by weight of magnesium oxide and not more than 10% by weight of calcium oxide.

EP 3 130 663 A1 relates to reinforced, in particular long glass fiber-reinforced, polyamides which exhibit good mechanics and better shrinkage during processing. The polyamides comprise special glass fibers composed of 57.5% to 59.5% by weight of SiO₂, 17% to 20% by weight of Al₂O₃, 11% to 13.5% by weight of CaO and 8.5% to 12.5% by weight of MgO.

It is an object of the invention to provide thermoplastic molding materials comprising thermoplastic polyamides which coupled with high stiffness and strength exhibit an increased weld seam strength. Furthermore, the thermoplastic molding materials should have a low density.

It is a further object of the invention to provide an additive which makes it possible to achieve an increase in the weld seam strength and preferably simultaneously a reduction in the density of shaped articles made of thermoplastic molding materials comprising thermoplastic polyamides, wherein the molding materials further comprise at least one elastomer.

The object is achieved according to the invention through the use of glass fibers having a tensile strength according to DIN ISO 527-5 of 86.0 to 92.0 GPa, a tensile elastic modulus according to DIN ISO 527-5 of 2600 to 3200 MPa and a softening point according to DIN ISO 7884-1 of 900° C. to 950° C., preferably through the use of glass fibers of the following composition
B1) 55.5% to 62.0% by weight of SiO₂,
B2) 14.0% to 18.0% by weight of Al₂O₃,
B3) 11.0% to 16.0% by weight of CaO,
B4) 6.0% to 10.0% by weight of MgO,
B5) 0% to 4.0% by weight of further oxides,
   wherein the proportions of B3) CaO and B4) MgO sum to between 17.0% by weight and 24.0% by weight and the percentages by weight of B1) to B5) sum to 100% by weight, to increase the weld seam strength of shaped articles made of molding materials comprising thermoplastic polyamides.

The glass fibers have a tensile strength according to DIN ISO 527-5 of 86.0 to 92.0 GPa, a tensile elastic modulus according to DIN ISO 527-5 of 2600 to 3200 MPa and a softening point according to DIN ISO 7884-1 of 900° C. to 950° C.

The standards refer to the version in force in 2019.

The object is also achieved by a thermoplastic molding material comprising
a) 30.0% to 90.0% by weight of at least one thermoplastic polyamide as component A),
b) 10.0% to 70.0% by weight of glass fibers having a tensile strength according to DIN ISO 527-5 of 86.0 to 92.0 GPa, a tensile elastic modulus according to DIN ISO 527-5 of 2600 to 3200 MPa and a softening point according to DIN ISO 7884-1 of 900° C. to 950° C., preferably of the following composition
   B1) 55.5% to 62.0% by weight of SiO₂,
   B2) 14.0% to 18.0% by weight of Al₂O₃,
   B3) 11.0% to 16.0% by weight of CaO,
   B4) 6.0% to 10.0% by weight of MgO,
   B5) 0% to 4.0% by weight of further oxides,
   wherein the proportions of B3) CaO and B4) MgO sum to between 17.0% by weight and 24.0% by weight and the percentages by weight of B1) to B5) sum to 100% by weight, as component B),
c) 0% to 3.0% by weight of at least one heat stabilizer as component C),
d) 0% to 30.0% by weight of further additives and processing aids as component D),
   wherein the percentages by weight of the components A) to D) sum to 100% by weight.

The object is further achieved by a process for producing such a thermoplastic molding material by mixing the components A), B) and optionally C) and D).

The object is further achieved by use of the thermoplastic molding materials through production of fibers, films and shaped articles, by the corresponding fibers, films or shaped articles and by processes for the production thereof. Shaped articles are preferred.

It has been found according to the invention that the use of special glass fibers of the abovementioned composition results in an increase in the weld seam strength of polyamide molding materials, in particular compared to the use of glass fibers of other glass types, such as ECR glass fibers. It has further been found according to the invention that the increased weld seam strength occurs even at reduced usage amounts of the glass fibers, so that the density of the molding materials is reduced significantly through a reduced fiber content. The use of the special glass fibers thus makes it possible to combine an increase in weld seam strength with a reduction in density and a reduction in usage amounts.

Weld seam strength is a specific criterion in shaped articles produced by injection molding, wherein during injection molding at least two flow fronts of the molten polyamide composition collide and form at least one weld seam.

According to the invention the term “weld seam” is to be understood as meaning a dynamic “weld seam” as described at the outset. The term “weld seam” may also be substituted by the terms “flow line” or “weld line”. It is essential that the weld seam is obtained by injection molding of the polyamide composition. The weld seams are often the weak points in the injection molded shaped article. Especially in the case of excessively rapid cooling of the polyamide composition on the mold wall of the injection mold the confluent mass flow can no longer be optimally joined. This results in formation of weld seams or else of small notches which then constitute a weak point in the injection molded part. Mechanical stress often brings about a fracture along the weld seam/flow line or a fracture starts in this region. Weld seam strength is therefore important for the strength of the injection molded shaped article as a whole.

The components of the thermoplastic molding materials according to the invention are more particularly elucidated hereinbelow.

Component A)

As component A) the thermoplastic molding materials comprise 30.0% to 90.0% by weight, by preference 40.0% to 85.0% by weight, preferably 50.0% to 80.0% by weight, in particular 60.0% to 74.9% by weight, of at least one thermoplastic polyamide.

Co-use of the component C) causes the maximum possible amount to be reduced by the minimum usage amount of the component C), so that all proportions by weight sum to 100% by weight. The use of the component C) (heat stabilizer) thus results in ranges from 30.0% to 89.99% by weight, preferably 40.0% to 84.98% by weight, in particular 50.0% to 79.95% by weight, especially 60.0% to 74.90% by weight.

The polyamides of the molding materials according to the invention generally have a viscosity number of 90 to 210 ml/g, preferably 110 to 160 ml/g, determined in a 0.5% by weight solution in 96.0% by weight sulfuric acid at 25° C. according to ISO 307.

Semicrystalline or amorphous resins having a molecular weight (weight average) of at least 5000, such as are described for example in U.S. Pat. Nos. 2,071,250, 2,071,251, 2,130,523, 2,130,948, 2,241,322, 2,312,966, 2,512,606 and 3,393,210, are preferred.

Examples thereof are polyamides which derive from lactams having 7 to 13 ring members, such as polycaprolactam, polycaprylolactam and polylaurolactam, and also polyamides obtained by reaction of dicarboxylic acids with diamines.

Employable dicarboxylic acids include alkanedicarboxylic acids having 6 to 12 carbon atoms, in particular 6 to 10 carbon atoms, and aromatic dicarboxylic acids. These only include the acids adipic acid, azelaic acid, sebacic acid, dodecanedioic acid and terephthalic and/or isophthalic acid.

Particularly suitable diamines include alkanediamines having 6 to 12, in particular 6 to 9, carbon atoms and m-xylylenediamine, di(4-aminophenyl)methane, di(4-aminocyclohexyl)methane, 2,2-di(4-aminophenyl)propane, 2,2-di(4-aminocyclohexyl)propane or 1,5-diamino-2-methylpentane.

Preferred polyamides are polyhexamethylene adipamide, polyhexamethylene sebacamide, polycaprolactam and copolyamide 6/66, in particular having a proportion of 5% to 95.0% by weight of caprolactam units.

Suitable polyamides further include those obtainable from w-aminoalkylnitriles such as for example aminocapronitrile (PA 6) and adipodinitrile with hexamethylenediamine (PA 66) by so-called direct polymerization in the presence of water, as described for example in DE-A10313681, EP-A-1 198 491 and EP 9 220 65.

Also suitable are polyamides obtainable for example by condensation of 1,4-diaminobutane with adipic acid at elevated temperature (polyamide 4,6). Production processes for polyamides having this structure are described for example in EP-A-38 094, EP-A-38 582 and EP-A-039 524.

Also suitable are polyamides obtainable by copolymerization of two or more of the abovementioned monomers or mixtures of a plurality of polyamides in any desired mixing ratio.

Suitable polyamides preferably have a melting point of less than 265° C.

The following nonexhaustive list includes the recited polyamides and also further polyamides within the meaning of the invention as well as the monomers present.

AB Polymers:

| | |
|---|---|
| PA 4 | pyrrolidone |
| PA 6 | ε -caprolactam |
| PA 7 | ethanolactam |
| PA 8 | caprylolactam |
| PA 9 | 9-aminopelargonic acid |
| PA 11 | 11-aminoundecanoic acid |
| PA 12 | laurolactam |

AA/BB Polymers:

| | |
|---|---|
| PA 46 | tetramethylenediamine, adipic acid |
| PA 66 | hexamethylenediamine, adipic acid |
| PA 69 | hexamethylenediamine, azelaic acid |
| PA 610 | hexamethylenediamine, sebacic acid |
| PA 612 | hexamethylenediamine, decanedicarboxylic acid |
| PA 613 | hexamethylenediamine, undecanedicarboxylic acid |
| PA 1212 | 1,12-dodecanediamine, decanedicarboxylic acid |
| PA 1313 | 1,13-diaminotridecane, undecanedicarboxylic acid |
| PA 6T | hexamethylenediamine, terephthalic acid |
| PA MXD6 | m-xylylenediamine, adipic acid |
| PA 9T | nonamethylenediamine, terephthalic acid |

AA/BB Polymers:

| | |
|---|---|
| PA6I | hexamethylenediamine, isophthalic acid |
| PA 6-3-T | trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PAPACM 12 | diaminodicyclohexylmethane, laurolactam |
| PA 6I/6T/PACMT | as per PA 6I/6T + diaminodicyclohexylmethane, |
| | terephthalic acid |
| PA 6T/6I/MACMT | as per PA 6I/6T + dimethyldiaminocyclohexyl- |
| | methane, terephthalic acid |
| PA 6T/6I/MXDT | as per PA 6I/6T + m-xylylenediamine, |
| | terephthalic acid |
| PA 12/MACMI | laurolactam, dimethyldiaminodicyclohexylmethane, |
| | isophthalic acid |
| PA 12/MACMT | laurolactam, dimethyldiaminodicyclohexylmethane, |
| | terephthalic acid |
| PA PDA-T | phenylenediamine, terephthalic acid |
| PA 6T/6I | (see PA 6T and PA 6I) |
| PA 6T/66 | (see PA 6T and PA 66) |

Component A) is optionally a blend of at least one aliphatic polyamide and at least one semiaromatic or aromatic polyamide.

Employed according to the invention as component A) for example are mixtures comprising polyamide 6 and polyamide 6.6 and optionally also polyamide 6I/6T. It is preferable to employ a majority of polyamide 6.6. The amount of polyamide 6 is preferably 5.0% to 50.0% by weight, particularly preferably 10.0% to 30.0% by weight, based on the amount of polyamide 6.6. In the event of co-use of polyamide 6I/6T the proportion thereof is preferably 10.0% to 25.0% by weight based on the amount of polyamide 6.6.

In place of or in addition to polyamide 6I/6T it is also possible to employ polyamide 6I or polyamide 6T or mixtures thereof.

Employed according to the invention in particular are polyamide 6, polyamide 66 and copolymers or mixtures thereof. The polyamide 6 or polyamide 66 preferably has a viscosity number in the range from 80 to 180 ml/g, in particular 85 to 160 ml/g, in particular 90 to 140 ml/g, determined in a 0.5% by weight solution in 96% by weight sulfuric acid at 25° C. according to ISO 307.

A suitable polyamide 66 preferably has a viscosity number in the range from 110 to 170 ml/g, particularly preferably 130 to 160 ml/g.

For suitable semicrystalline and amorphous polyamides reference may further be made to DE 10 2005 049 297. They have a viscosity number of 90 to 210 ml/g, preferably 110 to 160 ml/g, determined in a 0.5% by weight solution in 96% by weight sulfuric acid at 25° C. according to ISO 307.

In the polyamide 6 or polyamide 66 0% to 10% by weight, preferably 0% to 5% by weight, may be replaced by semiaromatic polyamides. It is particularly preferable when no semiaromatic polyamides are co-used.

The thermoplastic polyamide is preferably selected from polyamide 6, polyamide 66, polyamide 6.10, polyamide 6T/6I, polyamide 6T/6, polyamide 6T/66 and copolymers or mixtures thereof.

Component B)

As component B) the molding materials according to the invention comprise 10.0% to 70.0%, preferably 15.0% to 55.0% by weight and in particular 20.0% to 40.0% by weight, especially 25.0% to 35.0% by weight, of glass fibers having a tensile strength according to DIN ISO 527-5 of 86.0 to 92.0 GPa, a tensile elastic modulus according to DIN ISO 527-5 of 2600 to 3200 MPa and a softening point according to DIN ISO 7884-1 of 900° C. to 950° C., preferably having the following composition
B1) 55.5% to 62.0% by weight of SiO₂,
B2) 14.0% to 18.0% by weight of Al₂O₃,
B3) 11.0% to 16.0% by weight of CaO,
B4) 6.0% to 10.0% by weight of MgO,
B5) 0% to 4.0% by weight of further oxides,
   wherein the proportions of B3) CaO and B4) MgO sum to between 17.0% by weight and 24.0% by weight and the percentages by weight of B1) to B5) sum to 100% by weight.

Further oxides B5) are to be understood as meaning oxides of the elements Li, Zn, Mn, Le, V, Ti, Be, Sn, Ba, Zr, Sr, Fe, B, Na, K or mixtures thereof.

For example the glass fibers may comprise up to 1% by weight, preferably up to 0.5% by weight of Li₂O and/or TiO₂.

Fe₂O₃ and/or B₂O₃ may, if present, be comprised in amounts of 0.1% to 3% by weight, preferably 0.2% to 3% by weight.

According to the invention oxides of the elements Zn, Mn, Le, V, Be, Sn, Ba, Zr, Sn may, if present, each be comprised in amounts of 0.05% to 3% by weight, preferably of 0.2% to 1.5% by weight.

Suitable amounts for Na₂O and/or K₂O are, if present, at least 0.2% by weight, preferably 0.3% by weight to 4% by weight.

Essential preferred aspects of the glass fiber composition according to the invention are:
a) the ratio MgO (B4):Al₂O₃(B2) is preferably at least 1.4 to not more than 3.0, in particular from 1.5 to 2.8,
b) the ratio MgO (B4):CaO (B3) is preferably 1.4 to 2.7, in particular from 1.2 to 2.6.

The sums of MgO+CaO and MgO+Al₂O₃ are especially restricted to the following ranges:
a) 17.0% by weight <MgO+CaO<24.0% by weight, in particular 18.0% by weight <MgO+CaO<23.0% by weight, and
b) 20.0% by weight <MgO+Al₂O₃<26.0% by weight, in particular 21.0% by weight <MgO+Al₂O₃<25.0% by weight.

Production of the glass fibers B) is in general form disclosed in WO 2013/156477 and EP 3 130 633 A1. For further details explicit reference is made to this document.

It is preferable to employ glass fibers B) having a fiber length of 2 to 20 mm, in particular of 3 to 10 mm, and/or an L/D ratio of 200 to 2000, preferably of 200 to 800.

The glass fibers B) may be surface-pretreated with a silane compound for better compatibility with the thermoplastics. Suitable silane compounds are those of general formula

(X—(CH₂)ₙ)ₖ—Si—(O—CₘH₂ₘ₊₁)₄₋ₖ,

in which the substituents are defined as follows:

X: NH₂₋, HO—,

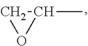

n: an integer from 2 to 10, preferably 3 to 4,

m: an integer from 1 to 5, preferably 1 to 2,

k: an integer from 1 to 3, preferably 1.

Preferred silane compounds are aminopropyltrimethoxysilane, aminobutyltrimethoxysilane, aminopropyltriethoxysilane, aminobutyltriethoxysilane and also the corresponding silanes which comprise a glycidyl group as substituent X.

The silane compounds are generally used for surface coating in amounts of 0.01% to 2%, preferably 0.025% to 1.0% and in particular 0.05% to 0.5% by weight (based on B)).

Other suitable coating compositions (also known as sizes) are based on isocyanates, phenolic resins or acrylic acid derivatives.

The polyamide molding materials according to the invention can be produced by the known processes for producing long fiber-reinforced rod pellets, especially by pultrusion processes, in which the continuous fiber strand (roving) is fully saturated with the polymer melt and then cooled and chopped. The long fiber-reinforced rod pellets obtained in this manner, which preferably have a pellet length of 3 to 25 mm, especially of 4 to 12 mm, may be processed further to afford moldings by the customary processing methods, for example injection molding or press molding.

Component C)

As component C) the compositions according to the invention comprise 0% to 3.0% by weight, preferably 0% to 2.0% by weight, particularly preferably 0% to 1.0% by weight, in particular 0% to 0.3% by weight, of at least one heat stabilizer. If a heat stabilizer is present the amounts are 0.01 to 3.0% by weight, preferably 0.02% to 2.0% by weight, especially preferably 0.05% to 1.0% by weight, in particular 0.1% to 0.3% by weight.

In the event of co-use of component C) the upper limit for the component A) is reduced correspondingly. For example, at a minimum amount of 0.01% by weight of the component C) the upper limit for the amount of component A) is 89.99% by weight.

Any desired suitable individual heat stabilizers or mixtures of two or more heat stabilizers may be employed according to the invention.

The heat stabilizers are preferably selected from copper compounds, secondary aromatic amines, sterically hindered phenols, phosphites, phosphonites and mixtures thereof.

If a copper compound is used the amount of copper is preferably 0.003% to 0.5% by weight, in particular 0.005% to 0.3% by weight and particularly preferably 0.01% to 0.2% by weight based on the total weight of the composition.

If stabilizers based on secondary aromatic amines are used the amount of these stabilizers is preferably 0.2% to 2% by weight, particularly preferably 0.2% to 1.5% by weight, based on the total weight of the composition.

If stabilizers based on sterically hindered phenols are used the amount of these stabilizers is preferably 0.1% to 1.5% by weight, particularly preferably 0.2% to 1% by weight, based on the total weight of the composition.

If stabilizers based on phosphites and/or phosphonites are used the amount of these stabilizers is preferably 0.1% to 1.5% by weight, particularly preferably from 0.2% to 1% by weight, based on the total weight of the composition.

Suitable compounds C) of mono- or divalent copper are, for example, salts of mono- or divalent copper with inorganic or organic acids or mono- or dihydric phenols, the oxides of mono- or divalent copper or the complexes of copper salts with ammonia, amines, amides, lactams, cyanides or phosphines, preferably Cu(I) or Cu(II) salts of the hydrohalic acids or of the hydrocyanic acids or the copper salts of the aliphatic carboxylic acids. Particular preference is given to the monovalent copper compounds CuCl, CuBr, CuI, CuCN and Cu₂O and to the divalent copper compounds CuCl₂, CuSO₄, CuO, copper(II) acetate or copper(II) stearate.

The copper compounds are commercially available and/or the production thereof is known to those skilled in the art. The copper compound may be used as such or in the form of concentrates. A concentrate is to be understood as meaning a polymer, preferably of the same chemical nature as component A), comprising a high concentration of the copper salt. The use of concentrates is a customary process and is particularly often employed when very small amounts of an input material are to be added. It is advantageous to employ the copper compounds in combination with further metal halides, in particular alkali metal halides, such as NaI, KI, NaBr, KBr, wherein the molar ratio of metal halide to copper halide is 0.5 to 20, preferably 1 to 10 and particularly preferably 3 to 7.

Particularly preferred examples of stabilizers which are based on secondary aromatic amines and are usable in accordance with the invention include adducts of phenylenediamine with acetone (Naugard® A), adducts of phenylenediamine with linolenic acid, 4,4′-bis(α,α-dimethylbenzyl)diphenylamine (Naugard® 445), N,N′-dinaphthyl-p-phenylenediamine, N-phenyl-N′-cyclohexyl-p-phenylenediamine or mixtures of two or more thereof.

Preferred examples of stabilizers employable according to the invention and based on sterically hindered phenols include N,N′-hexamethylenebis-3-(3,5-di-tert-butyl-4-hydroxyphenyl)propionamide, bis(3,3-bis(4′-hydroxy-3′-tert-butylphenyl)butanoic acid) glycol ester, 2,1′-thioethyl bis(3-(3,5-di-tert-butyl-4-hydroxyphenyl))propionate, 4,4′-butylidenebis(3-methyl-6-tert-butylphenol), triethylene glycol 3-(3-tert-butyl-4-hydroxy-5-methylphenyl)propionate or mixtures of two or more of these stabilizers.

Preferred phosphites and phosphonites are triphenyl phosphite, diphenyl alkyl phosphite, phenyl dialkyl phosphite, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythrityl diphosphite, bis(2,4-di-tert-butylphenyl) pentaerythrityl diphosphite, bis(2,6-di-tert-butyl-4-methylphenyl) pentaerythrityl diphosphite, diisodecyloxy pentaerythrityl diphosphite, bis(2,4-di-tert-butyl-6-methylphenyl) pentaerythrityl diphosphite, bis(2,4,6-tris(tert-butylphenyl)) pentaerythrityl diphosphite, tristearylsorbitol triphosphite, tetrakis(2,4-di-tert-butylphenyl)-4,4′-biphenylene diphosphonite, 6-isooctyloxy-2,4,8,10-tetra-tert-butyl-12H-dibenzo-[d,g]-1,3,2-dioxaphosphocin, 6-fluoro-2,4,8,10-tetra-tert-butyl-12-methyldibenzo-[d,g]-1,3,2-dioxaphosphocin, bis(2,4-di-tert-butyl-6-methylphenyl)methyl phosphite and bis(2,4-di-tert-butyl-6-methylphenyl) ethyl phosphite. Preference is given in particular to tris[2-tert-butyl-4-thio(2′-methyl-4′-hydroxy-5′-tert-butyl)phenyl-5-methyl]phenyl phosphite and tris(2,4-di-tert-butylphenyl) phosphite (Hostanox® PAR24: commercially available from BASF SE).

A preferred embodiment of the heat stabilizer consists in the combination of organic heat stabilizers (especially Hostanox PAR 24 and Irganox 1010), a bisphenol A-based epoxide (especially Epikote 1001) and copper stabilization based on CuI and KI. An example of a commercially available stabilizer mixture consisting of organic stabilizers and epoxides is Irgatec® NC66 from BASF SE. Heat stabilization based exclusively on CuI and KI is especially preferred. Other than the addition of copper or copper compounds, the use of further transition metal compounds, especially metal salts or metal oxides of group VB, VIB, VIIB or VIIIB of the Periodic Table, is possible or else precluded. It may moreover be preferable not to add transition metals of group VB, VIB, VIIB or VIIIB of the Periodic Table, for example iron powder or steel powder, to the molding material according to the invention or not. Irganox® 1098 (N,N′-hexane-1,6-diylbis [3-(3,5-di-tert-butyl-4-hydroxyphenyl) propionamide]) may also be preferably employed as a heat stabilizer.

Component D)

As component D) the compositions according to the invention comprise 0% to 30.0% by weight, preferably 0% to 20.0% by weight, in particular 0% to 10.0% by weight, especially 0% to 5.0% by weight, of further additives. If such additives are co-used the minimum amount is 0.1% by weight, preferably 0.5% by weight, in particular 0.8% by weight.

If component D) is co-used the upper limit for the component A) is reduced correspondingly. Thus, at a minimum amount of 0.1% by weight of the component D) the upper limit for the amount of component A) is 88.9% by weight for example.

Contemplated further additives include glass fibers distinct from component B), fillers and reinforcers distinct from glass fibers, thermoplastic polymers distinct from component A) or other additives.

As component D) the thermoplastic molding materials may comprise 0% to 20% by weight, preferably 0% to 10% by weight, particularly preferably 0% to 5% by weight, of glass fibers distinct from component B).

Chopped glass fibers are especially employed. The component D) especially comprises glass fibers, wherein short fibers are preferably employed. These preferably have a length in the range from 2 to 50 mm and a diameter of 5 to 40 μm. It is alternatively possible to use continuous fibers (rovings). Suitable fibers include those having a circular and/or noncircular cross-sectional area, wherein in the latter case the dimensional ratio of the main crosssectional axis to the secondary cross-sectional axis is especially >2, preferably in the range from 2 to 8 and particularly preferably in the range from 3 to 5.

In a specific embodiment the component D) comprises so-called “flat glass fibers”. These specifically have an oval or elliptical cross-sectional area or a necked elliptical (so-called “cocoon” fibers) or rectangular or virtually rectangular cross-sectional area. Preference is given here to using glass fibers with a noncircular cross-sectional area and a dimensional ratio of the main cross-sectional axis to the secondary cross-sectional axis of more than 2, preferably of 2 to 8, in particular of 3 to 5.

Reinforcement of the molding materials according to the invention may also be effected using mixtures of glass fibers having circular and noncircular cross sections. In a specific embodiment the proportion of flat glass fibers, as defined above, predominates, i.e. they account for more than 50% by weight of the total mass of the fibers.

When rovings of glass fibers are used as component D) said fibers preferably have a diameter of 10 to 20 μm, preferably of 12 to 18 μm. The cross section of these glass fibers may be round, oval, elliptical, virtually rectangular or rectangular. So-called flat glass fibers having a ratio of the cross-sectional axes of 2 to 5 are particularly preferred. E glass fibers are used in particular. However, it is also possible to use any other glass fiber types, for example A, C, D, M, S or R glass fibers, or any desired mixtures thereof or mixtures with E glass fibers.

In the context of the invention the term “filler and reinforcer” (=possible component D)) is to be interpreted broadly and comprises particulate fillers, fibrous substances distinct from glass fibers and any intermediate forms. Particulate fillers may have a wide range of particle sizes ranging from particles in the form of dusts to large grains. Contemplated filler materials include organic or inorganic fillers and reinforcers. Employable here are for example inorganic fillers, such as kaolin, chalk, wollastonite, talc, calcium carbonate, silicates, titanium dioxide, zinc oxide, graphite, glass particles, for example glass spheres, nanoscale fillers, such as carbon nanotubes, nanoscale sheet silicates, nanoscale alumina (Al₂O₃), nanoscale titanium dioxide (TiO₂), graphene, permanently magnetic or magnetizable metal compounds and/or alloys, phyllosilicates and nanoscale silicon dioxide (SiO₂). The fillers may also have been surface treated.

Examples of phyllosilicates usable in the molding materials according to the invention include kaolins, serpentines, talc, mica, vermiculites, illites, smectites, montmorillonite, hectorite, double hydroxides or mixtures thereof. The phyllosilicates may have been surface treated or may be untreated.

One or more fibrous substances may also be employed. These are preferably selected from known inorganic reinforcing fibers, such as boron fibers, carbon fibers, silica fibers, ceramic fibers and basalt fibers; organic reinforcing fibers, such as aramid fibers, polyester fibers, nylon fibers, polyethylene fibers and natural fibers, such as wood fibers, flax fibers, hemp fibers and sisal fibers.

It is especially preferable to employ carbon fibers, aramid fibers, boron fibers, metal fibers or potassium titanate fibers.

It is preferable when no glass fibers distinct from component B) and no other fillers and reinforcers are employed.

Thermoplastic polymers distinct from component A) may preferably be employed as component D).

The thermoplastic polymers distinct from component A) are preferably selected from
homo- or copolymers which comprise in copolymerized form at least one monomer selected from C₂-C₁₀-monoolefins, for example ethylene or propylene, 1,3-butadiene, 2-chloro-1,3-butadiene, vinyl alcohol and the C₂-C₁₀-alkyl esters thereof, vinyl chloride, vinylidene chloride, vinylidene fluoride, tetrafluoroethylene, glycidyl acrylate, glycidyl methacrylate, acrylates and methacrylates having alcohol components of branched and unbranched C₁-C₁₀-alcohols, vinylaromatics, for example styrene, acrylonitrile, methacrylonitrile, α,β-ethylenically unsaturated mono- and dicarboxylic acids, and maleic anhydride,
homo- and copolymers of vinyl acetals,
polyvinyl esters,
polycarbonates (PC),
polyesters, such as polyalkylene terephthalates, polyhydroxyalkanoates (PHA), polybutylene succinates (PBS), polybutylene succinate adipates (PBSA),
polyethers,
polyether ketones,
thermoplastic polyurethanes (TPU),
polysulfides,
polysulfones,
polyether sulfones,
cellulose alkyl esters
   and mixtures thereof.

Examples include polyacrylates having identical or different alcohol radicals from the group of C₄-C₈ alcohols, particularly of butanol, hexanol, octanol and 2-ethylhexanol, polymethylmethacrylate (PMMA), methyl methacrylate-butyl acrylate copolymers, acrylonitrile-butadiene-styrene copolymers (ABS), ethylene-propylene copolymers, ethylene-propylene-diene copolymers (EPDM), polystyrene (PS), styrene-acrylonitrile copolymers (SAN), acrylonitrilestyrene-acrylate (ASA), styrene-butadiene-methyl methacrylate copolymers (SBMMA), styrene-maleic anhydride copolymers, styrene-methacrylic acid copolymers (SMA), polyoxymethylene (POM), polyvinyl alcohol (PVAL), polyvinyl acetate (PVA), polyvinyl butyral (PVB), polycaprolactone (PCL), polyhydroxybutyric acid (PHB), polyhydroxyvaleric acid (PHV), polylactic acid (PLA), ethyl cellulose (EC), cellulose acetate (CA), cellulose propionate (CP) or cellulose acetate/butyrate (CAB).

The at least one thermoplastic polymer optionally also present in the molding material according to the invention is preferably polyvinyl chloride (PVC), polyvinyl butyral (PVB), homo- and copolymers of vinyl acetate, homo- and copolymers of styrene, polyacrylates, thermoplastic polyurethanes (TPUs) or polysulfides.

As component D) the thermoplastic molding materials may comprise 1.0% to 30.0% by weight, preferably 2.0% to 20.0% by weight, particularly preferably 3.0% to 10.0% by weight, in particular 3.5% to 7.0% by weight, of at least one elastomer.

The elastomer is preferably selected from
d1) copolymers of ethylene with at least one comonomer selected from C₃₋₁₂-olefins, C₁₋₁₂-alkyl (meth)acrylates, (meth)acrylic acid, maleic anhydride, as component D1),
d2) polyethylene or polypropylene as component D2),
   wherein components D1) and D2) may also be additionally grafted with maleic anhydride.

Component D1) may comprise one or more different comonomers, preferably one to three different copolymers, particularly preferably one or two different comonomers. The C₃₋₁₂-olefins are preferably terminal, linear C₃₋₁₂-olefins, particularly preferably C₃₋₈-olefins. Examples of suitable olefins are propylene, 1-butene, 1-pentene, 1-hexene, 1-heptene and 1-octene.

The C₁₋₁₂-alkyl (meth)acrylates comprise C₁₋₁₂-alkyl radicals, preferably C₂₋₆-alkyl radicals, such as methyl, ethyl, propyl, butyl, pentyl, hexyl, ethylhexyl radicals. Alkyl acrylates are preferably concerned.

In the copolymers of component D1) the proportion of ethylene base units is preferably 1% to 99% by weight, particularly preferably 60% to 98% by weight, especially preferably 84% to 96% by weight.

The following preferred amounts apply for the comonomers:
C₃₋₁₂-olefins: preferably 99% to 1% by weight, particularly preferably 40% to 10% by weight,
C₁₋₁₂-alkyl (meth)acrylates: preferably 40% to 2% by weight, particularly preferably 30% to 5% by weight,
(Meth)acrylic acid: preferably 40% to 2% by weight, particularly preferably 30% to 5% by weight,
Maleic anhydride: preferably 3% to 0.01% by weight, particularly preferably 2% to 0.1% by weight.

The total amount of comonomers is preferably in the range from 1% to 99% by weight, particularly preferably 2% to 40% by weight.

The copolymers of component D1) may be random or block copolymers. The former consist of a crystallizing and thus physically crosslinking main polymer (polyethylene) whose degree of crystallization is reduced by a comonomer randomly incorporated along the chain so that the crystallites in the finished molding material are no longer in direct contact. They then act as insulated crosslinking points as in conventional elastomers.

In block copolymers the hard and soft segments in a molecule are highly distinct. In thermoplastic elastomers the material demixes into a continuous phase and a discontinuous phase below a certain temperature. As soon as the latter falls below its glass temperature it in turn acts as a crosslinking point.

The copolymer of component D1) may also additionally be grafted with maleic anhydride. The maleic anhydride used for the grafting is preferably employed in an amount of 5% to 0.005% by weight, particularly preferably 3% to 0.01% by weight, based on the copolymer of the component D1). In the grafted copolymer of the component D1) the maleic anhydride proportion is preferably in the range from 2% to 0.1% by weight based on the ungrafted copolymer of the component D1).

Component D1) preferably has a melt flow index value (MVR) (190° C./2.16 kg, according to ISO1133) of 0.1 to 20 cm³/10 min, particularly preferably 0.1 to 15 cm³/10 min.

Employable alternatively or in addition to the component D1) as component D2) is polyethylene or polypropylene or a mixture of both. This component D2) may also additionally be grafted with maleic anhydride, wherein the proportion of maleic anhydride based on the polyolefin is 5% to 0.005% by weight, particularly preferably 2% to 0.1% by weight.

Component D2) preferably has an MVR value (190° C./2.16 kg, according to ISO1133) of 0.1 to 20 cm³/10 min, particularly preferably 0.1 to 15 cm³/10 min.

The term “elastomer” describes the components D1) and D2) which may optionally be grafted with maleic anhydride. Thermoplastic elastomers (TPE) may preferably be concerned. At room temperature TPE exhibit behavior comparable to the classical elastomers but are plastically deformable when heated and thus exhibit thermoplastic behavior.

Also employable according to the invention are mixtures of the components D1) and D2). These are in particular elastomer alloys (polyblends).

The thermoplastic elastomers are usually copolymers comprising a “soft” elastomer component and a “hard” thermoplastic component. Their properties are thus between those of elastomers and thermoplastics.

Polyolefin elastomers (POE) are polymerized for example through the use of metallocene catalysts, possible examples including ethylene-propylene elastomers (EPR or EPDM).

The most common polyolefin elastomers are copolymers of ethylene and butene or ethylene and octene.

For a further description of the elastomers suitable as component D) reference may be made to U.S. Pat. Nos. 5,482,997, 5,602,200, 4,174,358 and WO 2005/014278 A1.

Examples of suitable elastomers are obtainable for example from lyondellbasell under the designations Lucalen® A2540D and Lucalen® A2700M. Lucalen® A2540D is a low density polyethylene comprising n-butyl acrylate as comonomer. It has a density of 0.923 g/cm³ and a Vicat softening temperature of 85° C. at a butyl acrylate proportion of 6.5% by weight.

Lucalen® A2700M is a low density polyethylene likewise comprising a butyl acrylate comonomer. It has a density of 0.924 g/cm³, a Vicat softening temperature of 60° C. and a melting temperature of 95° C.

The polymer resin Exxelor™ VA 1801 from ExxonMobil is a semicrystalline ethylene copolymer functionalized with maleic anhydride by reactive extrusion and having an intermediate viscosity. The polymer backbone is fully saturated. The density is 0.880 g/cm³ and the proportion of maleic anhydride is typically in the range from 0.5% to 1.0% by weight.

Further suitable components D) are known to those skilled in the art.

Suitable preferred additives D) are lubricants but also flame retardants, light stabilizers (UV stabilizers, UV absorbers or UV blockers), dyes and nucleating agents and optionally also metallic pigments, metal flakes, metal-coated particles, antistats, conductivity additives, demolding agents, optical brighteners, defoamers, etc.

The molding materials according to the invention may comprise as additive E) 0% to 20.0% by weight, particularly preferably 0% to 10.0% by weight, based on the total weight of the composition, of at least one flame retardant. When the molding materials according to the invention comprise at least one flame retardant, preferably in an amount of 0.01 to 20% by weight, particularly preferably of 0.1 to 10% by weight, based on the total weight of the composition. Suitable flame retardants include halogen-containing and halogen-free flame retardants and synergists thereof (see also Gächter/Müller, 3rd edition 1989 Hanser Verlag, chapter 11). Preferred halogen-free flame retardants are red phosphorus, phosphinic or diphosphinic acid salts and/or nitrogen-containing flame retardants such as melamine, melamine cyanurate, melamine sulfate, melamine borate, melamine oxalate, melamine phosphate (primary, secondary) or secondary melamine pyrophosphate, neopentyl glycol boric acid melamine, guanidine and derivatives thereof known to those skilled in the art, and also polymeric melamine phosphate (CAS No.: 56386-64-2 and 218768-84-4 and also EP-A-1 095 030), ammonium polyphosphate, trishydroxyethyl isocyanurate (optionally also ammonium polyphosphate in a mixture with trishydroxyethyl isocyanurate) (EP-A-058 456 7). Further N-containing or P-containing flame retardants or PN condensates suitable as flame retardants, as well as the synergists customary therefor such as oxides or borates, may be found in DE-A-10 2004 049 342. Suitable halogenated flame retardants are for example oligomeric brominated polycarbonates (BC 52 Great Lakes) or polypentabromobenzyl acrylates with N greater than 4 (FR 1025 Dead sea bromine), reaction products of tetrabromobisphenol A with epoxides, brominated oligomeric or polymeric styrenes, dechlorane, which are usually used with antimony oxides as synergists (for details and further flame retardants see DE-A-10 2004 050 025).

The thermoplastic molding materials according to the invention may comprise 0% to 1.5% by weight, preferably 0.05% to 1.5% by weight and particularly preferably 0.1% to 1% by weight of a lubricant.

Preference is given to Al salts, alkali metal salts, alkaline earth metal salts or esters or amides of fatty acids having from 10 to 44 carbon atoms, preferably having from 14 to 44 carbon atoms. The metal ions are preferably alkaline earth metal and Al, wherein Ca or Mg are particularly preferred. Preferred metal salts are Ca stearate and Ca montanate and also Al stearate. It is also possible to use mixtures of different salts in any desired mixing ratio.

The carboxylic acids may be mono- or dibasic. Examples include pelargonic acid, palmitic acid, lauric acid, margaric acid, dodecanedioic acid, behenic acid, and particularly preferably stearic acid, capric acid and montanic acid (mixture of fatty acids having from 30 to 40 carbon atoms).

The aliphatic alcohols may be mono- to tetrahydric. Examples of alcohols include n-butanol, n-octanol, stearyl alcohol, ethylene glycol, propylene glycol, neopentyl glycol, and pentaerythritol, preference being given here to glycerol and pentaerythritol.

The aliphatic amines may be mono- to trifunctional. Examples thereof are stearylamine, ethylenediamine, propylenediamine, hexamethylenediamine, and di(6-aminohexyl)amine, wherein ethylenediamine and hexamethylenediamine are particularly preferred. Preferred esters or amides are correspondingly glyceryl distearate, glyceryl tristearate, ethylenediamine distearate, glyceryl monopalmitate, glyceryl trilaurate, glyceryl monobehenate and pentaerythrityl tetrastearate. Ethylenebisstearamide (EBS) is especially preferred.

It is also possible to use mixtures of different esters or amides or esters combined with amides in any desired mixing ratio.

As component D) the polyamide compositions according to the invention may comprise nigrosin, preferably in an amount of 0.05% to 1% by weight, particularly preferably 0.1% to 0.5% by weight, in particular 0.2% to 0.4% by weight, based on the molding material.

Nigrosin (Solvent Black 7—CAS: 8005-02-5) is a deep-black organic dye.

Nigrosin is a mixture of synthetic black colorants and is obtained by heating nitrobenzene, aniline and aniline hydrochloride in the presence of an iron or copper catalyst. Nigrosins are available in various forms (water-soluble, alcohol-soluble and oil-soluble). A typical water-soluble nigrosin is Acid Black 2 (C.I. 50420), a typical alcohol soluble nigrosin is Solvent Black 5 (C.I. 50415), and a typical oil-soluble nigrosin is Solvent Black 7 (C.I. 50415:1).

However, nigrosin is not unconcerning in terms of a possible damaging effect on health. For example residues of aniline and nitrobenzene may remain in the product as a consequence of production and there is a risk of unwanted decomposition products being formed in the course of subsequent processing by extrusion methods, injection molding methods or spinning methods.

The addition of nigrosin to the polyamide compositions according to the invention can further reduce the crystallization tendency of the polyamide composition since nigrosin disrupts crystallization. Thus, the addition results in a slower crystallization/reduction in the crystallization temperature.

It may additionally be advantageous to use Solvent Black 28 (CAS No. 12237-23-91) and to optionally combine it with at least one further colorant. Component D) is then preferably selected from non-nucleating colorants distinct from nigrosin. These include non-nucleating dyes, non-nucleating pigments and mixtures thereof. Examples of non-nucleating dyes are Solvent Yellow 21 (commercially available as Oracet® Yellow 160 FA from BASF SE) or Solvent Blue 104 (commercially available as Solvaperm® Blue 2B from Clariant). Examples of non-nucleating pigments are Pigment Brown 24 (commercially available as Sicotan® Yellow K 2011 FG from BASF SE). Also useful as component D) are small amounts of at least one white pigment. Suitable white pigments are titanium dioxide (Pigment White 6), barium sulfate (Pigment White 22), zinc sulfide (Pigment White 7) etc. In a specific embodiment the molding material according to the invention comprises 0.001% to 0.5% by weight of at least one white pigment as component E). For example, the molding material may comprise 0.05% by weight of Kronos 2220 titanium dioxide from Kronos.

The manner and amount of the addition is guided by the hue, i.e. the desired shade of the black color. For example, with Solvent Yellow 21, it is possible to move the hue of the black color in the CIELAB color space from, for example, b*=−1.0 in the direction of +b*, i.e. in the yellow direction. This method is known to those skilled in the art as color shading. Measurement is effected in accordance with DIN 6174 “Colorimetric evaluation of colour coordinates and colour differences according to the approximately uniform CIELAB colour space” or the successor standard.

Co-use of carbon black as component D) is also possible. The compositions according to the invention comprise for example 0.05% to 3% by weight, by preference 0.07% to 1% by weight, preferably 0.1% to 0.2% by weight, of carbon black. Carbon black, also known as industrial carbon black, is a modification of carbon with a high surface-to-volume ratio and consists of 80% to 99.5% by weight of carbon. The specific surface area of industrial carbon black is about 10 to 1500 m²/g (BET). The carbon black may have been produced in the form of channel black, furnace black, flame black, cracking black or acetylene black. The particle diameter is in the range from 8 to 500 nm, typically 8 to 110 nm. Carbon black is also referred to as Pigment Black 7 or Lamp Black 6. Color blacks are nanoparticulate carbon blacks that, due to their fineness, increasingly lose the brown base hue of conventional carbon blacks.

Employable as component D) in addition to carbon black and nigrosin is also at least one additional colorant selected from anthraquinone colorants, benzimidazolone colorants and perinone colorants. The colorants are preferably dyes, pigments or mixtures thereof.

According to the invention the colorant is employed in an amount of 10 to 1000 ppm, preferably 20 to 500 ppm, in particular 50 to 200 ppm, based on the total molding material.

The polyamide molding materials are produced by processes known per se. These include the mixing of the components in the appropriate proportions by weight.

It is also possible to employ recyclates of the individual components or else of mixtures, in particular of the components A) and B).

The mixing of the components is preferably accomplished at elevated temperatures by commixing, blending, kneading, extruding or rolling. The temperature during mixing is preferably in a range from 220° C. to 340° C., particularly preferably from 240° C. to 320° C. and especially from 250° C. to 300° C. Suitable methods are known to those skilled in the art.

Shaped Articles

The present invention further relates to shaped articles produced using the polyamide molding materials according to the invention.

The polyamide molding materials may be used for producing moldings by any desired suitable processing techniques. Suitable processing techniques are especially injection molding, extrusion, coextrusion, thermoforming or any other known polymer shaping method. These and further examples may be found for example in “Einfärben von Kunststoffen” [Coloring of Plastics], VDI-Verlag, ISBN 3-18-404014-3. The shaped articles are preferably produced using a twin-screw extruder.

The present invention also relates to a process for producing the molding materials according to the invention which comprises mixing components A), B), and optionally C) and D) in the appropriate amounts, preferably by extrusion. This process may employ commercially available twin-screw extruders of different sizes (screw diameters). The temperature during the extrusion is 200° C. to 400° C., preferably 250° C. to 350° C., particularly preferably 250° C. to 320° C.

The shaped articles produced from the molding materials according to the invention are used for producing internal and external parts, preferably with a load-bearing or mechanical function, in the sectors of electrical, furniture, sports, mechanical engineering, sanitary and hygiene, medicine, energy technology and drivetrain technology, automobiles and other conveyances, casings material for telecommunications devices and apparatuses, consumer electronics, household appliances, mechanical engineering, heating, fastenings for installations or for containers, and ventilation components of all types.

The mechanics, in particular the impact resistance, of the moldings according to the invention is markedly higher, this being coupled with improved shrinkage.

Processing Method

Useful processing methods include not only the customary processing methods such as extrusion or injection molding but also:
CoBi injection or assembly injection molding for hybrid components where the polyester molding material according to the invention is combined with other compatible or incompatible materials, for example thermoplastics, thermosets or elastomers;
insert components, such as bearing seats or screw-thread inserts made of the polyester molding material according to the invention and overmolded with other compatible or incompatible materials, for example thermoplastics, thermosets or elastomers;
outsert components, such as frames, casings, or supports made of the polyamide molding material according to the invention into which functional elements made of other compatible or incompatible materials, for example thermoplastics, thermosets or elastomers, are injected;
hybrid components (elements made of the polyamide molding material according to the invention combined with other compatible or incompatible materials, for example thermoplastics, thermosets or elastomers) produced by composite injection molding, injection welding, assembly injection molding, ultrasound welding, frictional or laser welding, bonding, beading or riveting,
semifinished products and profiles (for example produced by extrusion, pultrusion, layering or lamination);
surface coating, laminating, chemical or physical metallization, flocking, where the polyamide molding material of the invention may be the substrate itself or the substrate support, or, in the case of hybrid/bi-injection components, may be a defined substrate region, which may also be brought to the surface by subsequent chemical treatment (for example etching) or physical treatment (for example machining or laser ablation);
printing, transfer printing, 3D printing, laser marking.

The polyamide compositions employed according to the invention are preferably used to produce shaped articles by injection molding, wherein during injection molding at least two flow fronts of the molten polyamide composition collide and form at least one weld seam.

The shaped articles thus have at least one weld seam arising from the injection molding process. The injection molding may be carried out according to known processes and is described for example in “Einfärben von Kunststoffen”, VDI-Verlag, ISBN 3-18-404014-3.

At least two injection points are typically provided in the mold in injection molding, thus resulting in the at least two flow fronts of the molten polyamide composition. Depending on the size and shape of the shaped article many more injection points may also be provided. The at least two flow fronts may form through flow around a cavity or core in the mold.

The shaped articles produced according to the invention may be one-part or multi-part articles. In the case of a multi-part construction the individual shaped articles must be joined to one another subsequently, for example through welding, such as friction welding, hot gas welding or laser transmission welding.

The examples that follow serve to elucidate the invention without restricting it in any way.

### EXAMPLES

The following input materials were used:
Polyamide 6: Ultramid® B27 from BASF SE, melting point: 220° C., viscosity number (0.5% in 96% H₂SO₄): 150 ml/g, amino end groups: 37 mmol/kg
ECR glass fiber: standard E-Glass NEG ChopVantage 3610HP (diameter: 10 μm)
High strength glass fiber: Composition: SiO₂: 60.8% by weight, Al₂O₃: 15.2% by weight, MgO: 6.8% by weight, CaO: 15.5% by weight, Na₂O: 0.8% by weight; treated with a silane size suitable for bonding to PA; diameter: 10 μm
Stabilizer: Irganox® 1098 from BASF SE (heat stabilizer)
Carbon black: Printex 60 from Orion Engineered Carbons GmbH
Lubricant: ethylenebisstearamide (EBS) from Lonza Cologne GmbH

The molding materials were produced by mixing the ingredients listed below in a twin-screw extruder ZE 25 A UTXi at temperatures of 260° C. The properties specified in table 1 below were determined by the specified standards valid 2019. The proportions of the ingredients are reported in % by weight.

The obtained pellet material was injection molded on an injection molding machine at a melt temperature of 290° C. to afford standard ISO dumbbells and assessed both visually and analytically. Production of the standard ISO dumbbells having a thickness of 4 mm and a length of 150 mm was carried out via injection points arranged opposite one another at the ends of the dumbbell so that the inflowing polyamide flowed from outside into the middle of the dumbbell to form a weld seam in the middle of the shaped article.

The weld seam strength was determined via a normalized braking stress test. Mechanical properties were determined according to DIN ISO 527 or 179-2/1 eU or 179-2/1 eAf (2019 version). The amounts reported in the table are in % by weight.

TABLE 1

| | | | | Comparison | Example | Comparison | Example | Comparison | Example |
|---|---|---|---|---|---|---|---|---|---|
| Composition | | | | 1 | 1 | 2 | 2 | 3 | 3 |
| Polyamide 6 | | | | 69.1 | 74.1 | 64.1 | 69.1 | 59.1 | 64.1 |
| ECR glass fiber | | | | 30 | 0 | 35 | 0 | 40 | 0 |
| High strength glass fiber | | | | 0 | 25 | 0 | 30 | 0 | 35 |
| Stabilizer | | | | 0.2 | 0.2 | 0.2 | 0.2 | 0.2 | 0.2 |
| Carbon black | | | | 0.5 | 0.5 | 0.5 | 0.5 | 0.5 | 0.5 |
| Lubricant | | | | 0.2 | 0.2 | 0.2 | 0.2 | 0.2 | 0.2 |
| | Unit | DIN | ISO | | | | | | |

Product features

| | | | | | | | | | |
|---|---|---|---|---|---|---|---|---|---|
| Density | g/cm³ | 53479 | 1183 | 1.36 | 1.31 | 1.41 | 1.36 | 1.46 | 1.41 |

Mechanical properties (dry)

| | | | | | | | | |
|---|---|---|---|---|---|---|---|---|
| Breaking stress | MPa | 527 | 174 | 175 | 187 | 192 | 198 | 205 |
| Breaking elongation | % | 527 | 3.2 | 4.4 | 3.0 | 3.6 | 3.3 | 3.9 |
| Charpy impact | kJ/m² | 179-2/1eU | 82 | 98 | 93 | 104 | 99 | 108 |
| strength | | | | | | | | |
| Charpy notched | kJ/m² | 179-2/1eAf | 10.2 | 12.8 | 12.9 | 13.5 | 14.5 | 14.7 |
| impact strength | | | | | | | | |

Weld line tensile test (dry)

| | | | | | | | | |
|---|---|---|---|---|---|---|---|---|
| Breaking energy | J | 527 | 1.40 | 1.56 | 1.25 | 1.48 | 1.10 | 1.30 |

1. A method of using glass fibers having a tensile elastic modulus according to DIN ISO 527-5 of 86.0 to 92.0 GPa, a tensile strength according to DIN ISO 527-5 of 2600 to 3200 MPa and a softening point according to DIN ISO 7884-1 of 900° C. to 950° C. the method comprising using the glass fibers to increase the weld seam strength of shaped articles made of molding materials comprising thermoplastic polyamides obtained by injection molding.

2. The method of use according to claim 1, wherein the glass fibers have the following composition:
B1) 55.5% to 62.0% by weight of SiO₂,
B2) 14.0% to 18.0% by weight of Al₂O₃,
B3) 11.0% to 16.0% by weight of CaO,
B4) 6.0% to 10.0% by weight of MgO, and
B5) 0% to 4.0% by weight of further oxides,
wherein the proportions of B3) CaO and B4) MgO sum to between 17.0% by weight and 24.0% by weight and the percentages by weight of B1) to B5) sum to 100% by weight.

3. The method of use according to claim 1, wherein the thermoplastic polyamide is selected from the group consisting of polyamide 6, polyamide 66, polyamide 6.10, polyamide 6T/6I, polyamide 6T/6, polyamide 6T/66 and copolymers and mixtures thereof.

4. A thermoplastic molding material comprising
a) 30.0% to 90.0% by weight of at least one thermoplastic polyamide as component A),
b) 10.0% to 70.0% by weight of glass fibers having a tensile elastic modulus according to DIN ISO 527-5 of 86.0 to 92.0 GPa, a tensile strength according to DIN ISO 527-5 of 2600 to 3200 MPa and a softening point according to DIN ISO 7884-1 of 900° C. to 950° C. as component B),
c) 0% to 3.0% by weight of at least one heat stabilizer as component C), and
d) 0% to 30.0% by weight of further additives and processing aids as component D), wherein the component D) comprises 0.05% to 3% by weight of carbon black,
wherein the percentages by weight of the components A) to D) sum to 100% by weight.

5. The thermoplastic molding material according to claim 4, wherein said thermoplastic molding material employs a component B) of the following composition
B1) 55.5% to 62.0% by weight of SiO₂,
B2) 14.0% to 18.0% by weight of Al₂O₃,
B3) 11.0% to 16.0% by weight of CaO,
B4) 6.0% to 10.0% by weight of MgO, and
B5) 0% to 4.0% by weight of further oxides,
wherein the proportions of B3) CaO and B4) MgO sum to between 17.0% by weight and 24.0% by weight and the percentages by weight of B1) to B5) sum to 100% by weight.

6. The thermoplastic molding material according to claim 4, wherein component D) comprises not only carbon black but also lubricant.

7. The thermoplastic molding material according to claim 4, wherein component C) is employed in an amount of 0.01% to 3.0% by weight.

8. The thermoplastic molding material according to claim 4, wherein component B) is selected from the group consisting of polyamide 6, polyamide 66, polyamide 6.10, polyamide 6T/6L, polyamide 6T/6, polyamide 6T/66 and copolymers and mixtures thereof.

9. The thermoplastic molding material according to claim 4, wherein component A) is employed in an amount of 15.0% to 55.0% by weight.

10. A process for producing the thermoplastic molding material according to claim 4, comprising mixing the components A), B) and optionally C) and D).

11. A method of using the thermoplastic molding material according to claim 4, the method comprising Using the thermoplastic molding material for producing fibers, films and shaped articles.

12. A fiber, film or shaped article made of a thermoplastic molding material according to claim 4.

13. A process for producing fibers, films or shaped articles, comprising extruding injection molding or blow molding the thermoplastic molding material according to claim 4.

14. The thermoplastic molding material according to claim 4, wherein component C) is employed in an amount of 0.02% to 2.0% by weight.

15. The thermoplastic molding material according to claim 4, wherein component C) is employed in an amount of 0.05% to 1.0% by weight.

16. The thermoplastic molding material according to claim 4, wherein component A) is employed in an amount of 20.0% to 40.0% by weight.

17. The thermoplastic molding material according to claim 4, wherein component A) is employed in an amount of 25.0% to 35.0% by weight.
